(19) United States
(12) Patent Application Publication
(10) Pub. No.: US 2017/0229948 A1
(43) Pub. Date: Aug. 10, 2017

(54) SINGLE PHASE BRUSHLESS DIRECT CURRENT MOTOR

(71) Applicant: G.E.T. KOREA CO., LTD., Gunpo-si, Gyeonggi-do (KR)

(72) Inventors: Young Mok NA, Cheongju-si, Chungcheongbuk-do (KR); Un Ho CHOI, Yongin-si, Gyeonggi-do (KR); Sang Yong JUNG, Seoul (KR)

(73) Assignee: G.E.T. KOREA CO., LTD., Gunpo-si, Gyeonggi-do (KR)

(21) Appl. No.: 15/501,179

(22) PCT Filed: Jul. 21, 2015
(86) PCT No.: PCT/KR2015/007565

§ 371 Date: Feb. 2, 2017

(30) Foreign Application Priority Data
Aug. 4, 2014 (KR) 10-2014-0099938

(51) Int. Cl. H02K 16/04; H02K 21/14; H02K 1/27

(52) U.S. Cl. CPC H02K 16/04; H02K 1/2706; H02K 21/14

(57) ABSTRACT

Disclosed is a single phase brushless direct current motor comprising a stator and a rotor which is rotatably located inside the stator, the stator comprising: a first stator core having a plurality of first core pieces which are formed to be bent from the inside; a second stator core having a plurality of second core pieces which are located between the first core pieces, respectively, and are formed to be bent from the inside; and a bobbin which is coupled between the first stator core and the second stator core, and around which a coil is wound, and the rotor comprising: a rotor body which rotates around a shaft; and a plurality of magnets which are formed on the outer circumferential surface of the rotor body, wherein the first core pieces and the second core pieces have overlapping regions which axially overlap when seen from the shaft.

### TECHNICAL FIELD

The present invention relates to a motor. More specifically, the present invention relates to a brushless DC motor using a single coil, thereby reducing manufacturing costs through a simple structure, enabling to drive with low power, and having high efficiency operation.

### BACKGROUND ART

In general, a brushless direct current (BLDC) motor consists of a three-phase winding, and applies an alternating current of square wave or sine wave for driving as a current of each phase. The representative conventional art reference of the three-phase brushless direct current motor is Korean Patent Laid-Open No. 10-2011-0048661 (hereinafter “Prior Art Reference 1”).

The BLDC motor according to Prior Art Reference 1 should wind coils corresponding to the three phases around a plurality of teeth protruding toward the inside of a ring-shaped stator, and the coils should be connected per phase. In order to control the direction and phase of the current supplied to the coil corresponding to each phase, a controller should be included. When an alternating current is applied to the coil of the stator by operation of the controller, an alternating magnetic field of N-pole or S-pole is generated in the magnetic poles of the stator, and the magnetic field of the stator and the permanent magnet of the rotor interact to generate a torque, thereby rotating the rotor and shaft together.

However, since the three-phase direct current motor should control the driving torque and rotational direction of the rotor by applying three phase currents having phase differences to the three-phase coil, it has a complicated structure of the stator, is difficult to wind the coil and is not easy to perform electrical connection of the coil of each phase, which result in an increase in manufacturing costs.

For the reasons above, a single phase motor may allow a simpler structure than a three-phase BLDC motor, but should use a separate driving circuit including a driving coil and a condenser for obtaining a phase difference of a current to drive the single phase motor. Accordingly, the single phase motor consumes much more driving power and decreases efficiency.

U.S. Pat. No. 4,899,075 (hereinafter “Prior Art Reference 2”) discloses a two-phase BLDC motor with a stator of a simplified structure. The motor according to Prior Art Reference 2 also needs to apply currents of two phases, and thus although the motor has a simpler structure of the stator than a three-phase motor, the control of the motor is somewhat complicate. Further, when a single phase current is applied to the two-phase motor, a dead point where the rotor does not rotate is generated.

Accordingly, the present inventors suggest a brushless direct current motor with a novel structure, which enables to simplify the structure of the motor and also achieve high efficiency, in order to solve the above-mentioned problems.

### DETAILED DESCRIPTION OF THE INVENTION

### Technical Task

It is an object of the present invention to provide a brushless direct current motor with a simple structure, capable of reducing manufacturing costs.

It is another object of the present invention to provide a brushless direct current motor of low power and high efficiency, capable of generating a driving torque without a control circuit or a driving circuit separately, thereby facilitating the control thereof.

It is yet another object of the present invention to provide a brushless direct current motor requiring no electrical control for determining the rotational direction because the rotational direction of a rotor can be determined by the mechanical design.

The objects above of the present invention and other objects included therein may be easily achieved by the present invention explained in the following.

### Means for Solving Technical Task

A single phase brushless direct current motor according to the present invention includes a stator and a rotor which is rotatably located inside the stator, the stator including a first stator core having a plurality of first core pieces which are formed to be bent from the inside; a second stator core having a plurality of second core pieces which are located between the first core pieces, respectively, and are formed to be bent from the inside; and a bobbin which is coupled between the first stator core and the second stator core, and around which a coil is wound, and the rotor including a rotor body which rotates around a shaft; and a plurality of magnets which are formed on the outer circumferential surface of the rotor body, wherein the first core pieces and the second cores piece have overlapping regions which axially overlap when seen from the shaft.

In the present invention, preferably, the end line of the first core piece and the end line of the second core piece have a certain interval therebetween.

In the present invention, preferably, the outer circumference of the first stator core and the outer circumference of the second stator core are in contact with each other in at least a portion thereof.

In the present invention, preferably, non-overlapping regions in which the first core pieces and the second core pieces do not overlap are located adjacent to the overlapping regions, and the non-overlapping region and the overlapping region are alternately located.

In the present invention, preferably, the first core pieces and the second core pieces in the overlapping regions have an asymmetric shape with different areas.

### Effect of the Invention

The present invention has the effects of the invention of providing a brushless direct current motor having a simple structure, thereby capable of reducing manufacturing costs, enabling to generate a driving torque without a control circuit or a driving circuit separately, thereby capable of facilitating the control thereof and achieving low power and high efficiency, and requiring no electrical control for determining the rotational direction because the rotational direction of a rotor can be determined by the mechanical design.

### BRIEF DESCRIPTION OF THE DRAWINGS

FIG. 1 is an exploded perspective view illustrating a single phase brushless motor according to the present invention;

FIG. 2 is a cross sectional view illustrating the cut single phase brushless motor according to the present invention;

FIG. 3 is a development view of the core pieces and magnets for explaining the driving principle of the single phase brushless motor according to the present invention;

FIG. 4 is a development view of the core pieces and magnets in another shape for explaining the driving principle of the single phase brushless motor according to the present invention; and

FIG. 5 is a development view of the core pieces and magnets in yet another shape for explaining the driving principle of the single phase brushless motor according to the present invention.

Hereinafter, the present invention will be explained in detail with reference to the accompanying drawings.

### BEST MODE FOR CARRYING OUT THE INVENTION

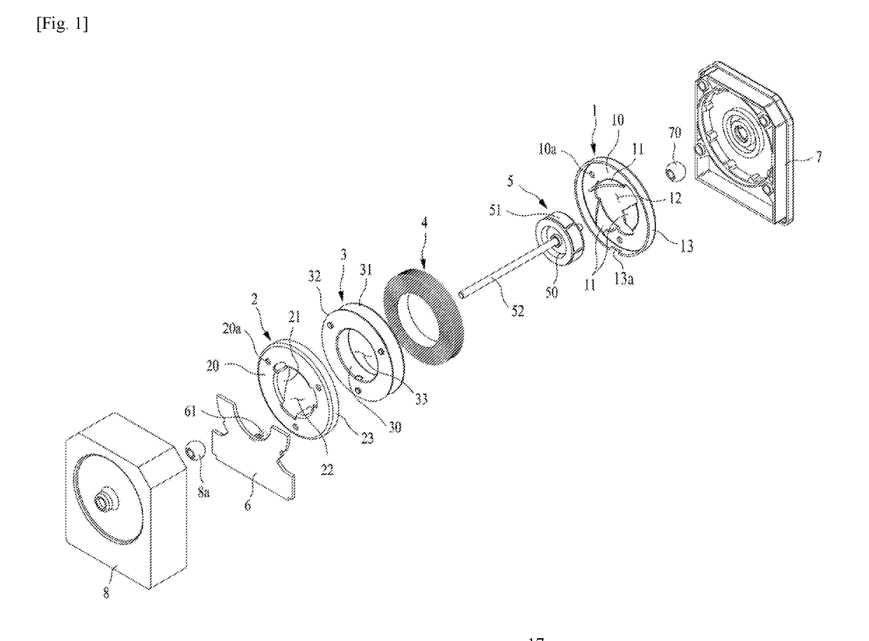

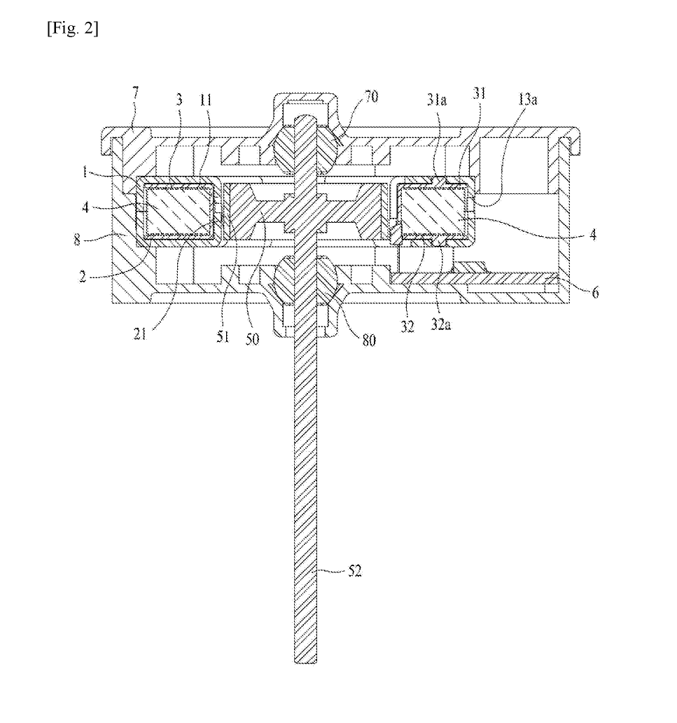

FIG. 1 is an exploded perspective view illustrating a single phase brushless motor according to the present invention, and FIG. 2 is a cross sectional view illustrating the cut single phase brushless motor according to the present invention.

As illustrated in FIG. 1 and FIG. 2, the single phase BLDC motor according to the present invention includes a first stator core 1, a second stator core 2, a bobbin 3, a coil 4, a rotor 5 and a printed circuit board 6.

The first stator core 1 and the second stator core 2 face each other and are located in the upper portion and the lower portion, respectively, to be coupled. For reference, as used herein, the term “upper portion” refers to the upper side in FIG. 2, and the term “lower portion” refers to the lower side on the basis of FIG. 2. The coil 4 is wound around the bobbin 3, and the single coil is wound by the winding numbers n in the horizontal direction. The winding numbers may be properly employed according to the output or required specifications of the motor. The end of the coil is electrically connected to the printed circuit board 6.

The bobbin 3 is located between the first stator core 1 and the second stator core 2, while the coil 4 is wound therearound. For the first and second stator cores 1, 2, a magnetic material is used which has a magnetic pole when a current is applied to the coil 4. For the bobbin 3, an insulating material is used for insulating the gap between the coil 4 and the first and second stator cores 1, 2.

The first stator core 1 includes a first bobbin receiving part 10 in which a first insulating part 31 of the bobbin 3 is located, a plurality of first core pieces 11 which are formed to protrude downwards from the first bobbin receiving part 10, a hollow part 12, as a space inside the inner circumference of the first core piece 11, in which the rotor 5 is located, and a first lateral surface part 13 which is formed to extend downwards from the circumference of the first bobbin receiving part 10.

The first bobbin receiving part 10 is a part to which the first insulating part 31 of the bobbin 3 is coupled. In order to secure more accurate location and rigid coupling, a plurality of first coupling protrusions 31a are formed in the first insulating part 31, and first coupling recesses 10a are formed in the first bobbin receiving part 10 at the locations corresponding to the first coupling protrusions 31a, such that the first coupling protrusions 31a are press-fitted into the first coupling recesses 10a.

The first core piece 11 is formed in the plural, and each of the first core pieces 11 is arranged at a certain interval and has the shape bent downwards on the inner circumferential surface of the first bobbin receiving part 10. Preferably, the first core pieces are formed to be in contact with the inner side surface of a hollow part 33 of the bobbin 3, i.e., the inside surface of a coil winding part 30. The first core pieces 11 are located to face magnets 51 of the rotor 5 located in the hollow part 12.

The first lateral surface part 13 is formed to extend downwards from the outer circumferential surface of the first bobbin receiving part 10. The first lateral surface part 13 is in the shape of a cylinder, as illustrated in FIG. 1, but is not necessarily limited to such shape and may be formed to extend in the shape of teeth, similar to the first core piece 11. A coil passage 13a through which the end of the coil 4 passes is formed in the first lateral surface part 13. Of course, the coil passage 13a may be formed in a second lateral surface part 23 or a second bobbin receiving part 20, not in the first lateral surface part 13. The location of the coil passage 13a may be variously selected and employed according to a design environment.

The second bobbin receiving part 20 is a part to which a second insulating part 32 of the bobbin 3 is coupled. In order to secure more accurate location and rigid coupling, a plurality of second coupling protrusions 32a are formed in the second insulating part 32, and second coupling recesses 20a are formed in the second bobbin receiving part 20 at the locations corresponding to the second coupling protrusions 32a, such that the second coupling protrusions 32a are press-fitted into the second coupling recesses 20a.

The second core piece 21 is formed in the plural, and each of the second core pieces 21 is arranged at a certain interval and has the shape bent upwards inside the second bobbin receiving part 20. Preferably, the second core pieces are formed to be in contact with the inner side surface of the hollow part 33 of the bobbin 3, i.e., the inside surface of the coil winding part 30. At the same time, the second core piece 21 is located in a space between the adjacent first core pieces 11. That is, the first and second core pieces 11, 21 are alternately located. The second core pieces 21 are located to face the magnets 51 of the rotor 5 located in a hollow part 22, in the same manner as the first core pieces 11.

The second lateral surface part 23 is formed to extend upwards from the outer circumferential surface of the second bobbin receiving part 20. The second lateral surface part 23 is in the shape of a cylinder, as illustrated in FIG. 1, but is not necessarily limited to such shape and may be formed to extend in the shape of teeth, similar to the second core piece 21. A contact portion should exist when the first lateral surface part 13 and the second lateral surface part 23 are coupled with the bobbin 3. That is, in case where the first and second lateral surface parts 13, 23 have the shape of a cylinder, as illustrated in FIG. 1, the outer circumferential surfaces thereof are formed to be in contact with each other. By being in contact with each other in such a manner, the two can magnetize the first core piece 11 and the second core piece 21 to have different magnetic poles, as a magnetic material. If the first lateral surface part 13 and the second lateral surface part 23 have the shape of teeth, at least one of the teeth are configured to be in contact with each other.

The coil 4 is wound around the winding part 30 of the bobbin 3, and the hollow part 33 is formed inside the winding part 30. The first and second core pieces 11, 21 are located in the hollow part 33 alternately along the inner circumferential direction, and the rotor 5 is located inside the first and second core pieces 11, 12. The bobbin 3 around which the coil 4 is wound, and the first and second stator cores 1, 2 surrounding the bobbin 3 form a stator, and the rotor 5 is located inside the stator and rotates.

The rotor 5 includes a rotor body 50 in the shape of a cylinder, a plurality of magnets 51 located on the outer circumferential surface of the rotor body 50, and a shaft 52 coupled to the center of the rotor body 50 and rotating together with the rotor body 50. The plurality of magnets 51 are located to face the first and second core pieces 11, 12, and receive a force to rotate the rotor body 50 along the direction of magnetic field formed by the first and second core pieces 11, 21. The structure of the first and second core pieces 11, 12 and the interaction with the magnets 51 will be explained again below.

The printed circuit board 6 is electrically connected with the coil 4 and electrically connected with an external power source. The printed circuit board 6 includes a circuit controlling the motor, etc., but does not include a driving circuit for initially rotating the rotor, as in the conventional single phase motor. In the printed circuit board 6, a hall sensor 61 is electrically connected, and the hall sensor 61 detects the location of the rotor 5, etc. The printed circuit board 6 may be located below the second stator core 2, as illustrated in FIG. 1 and FIG. 2, or may be located above the first stator core 1. The location of the printed circuit board 6 may be determined according to a design specification, etc.

The single phase brushless motor according to the present invention may be accommodated between a first case 7 and a second case 8. Also, a first bearing 70 and a second bearing 80 for supporting rotation of the shaft may be installed in the upper portion and the lower portion of the shaft 52 in the first case 7 and the second case 8, respectively.

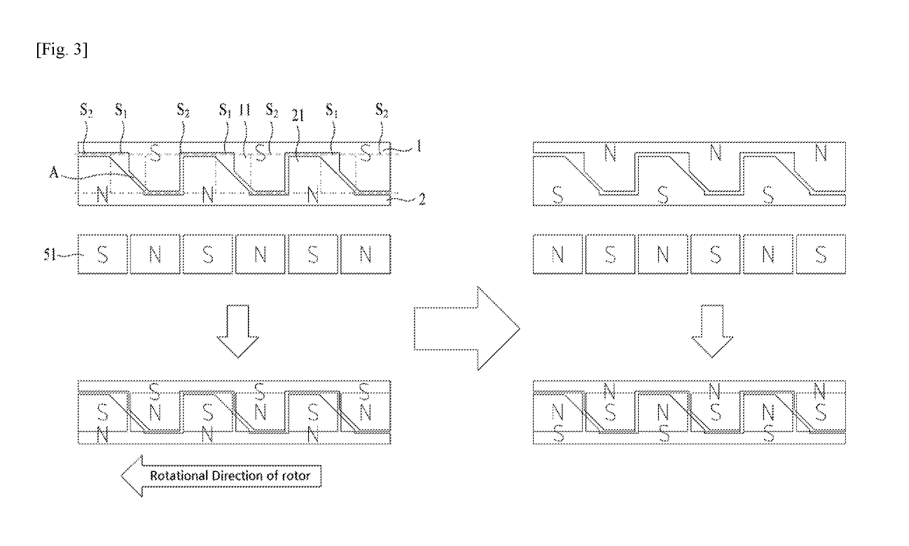

FIG. 3 is a development view of the core pieces 11, 21 and magnets 51 for explaining the driving principle of the single phase brushless motor according to the present invention.

With reference to FIG. 3, the single phase brushless motor according to the present invention includes the first stator core 1 and the second stator core 2 coupled to the upper portion and the lower portion of the bobbin 3, respectively, and surrounding the bobbin 3. The first and second core pieces 11, 12 formed in the first and second stator cores 1, 2, respectively, are located alternately at the location facing the magnets 51 of the rotor 5.

The first core pieces 11 and the second core pieces 21 have overlapping regions S₁ overlapping with each other and non-overlapping regions S₂ not overlapping with each other alternately, in the vertical direction or axial direction, when viewed from the shaft 52 or magnet 51. To this end, the first core pieces 11 have an oblique portion, and the second core pieces 21 facing the oblique portion of the first core pieces 11 also have an oblique portion. Part of the oblique portion may have a notched shape as in the first core pieces 11 illustrated in FIG. 3. That is, any core piece in the overlapping region S₁ may have a notched shape in the portion thereof. The lower end line of the first core piece 11 and the upper end line of the second core piece 21 have a certain interval A. The size of interval is not specifically limited and may be variously modified and employed according to the design specification of a motor.

When the overlapping region S₁ and non-overlapping region S₂ are alternately located, a certain correlation is formed with the areas of the magnetic poles of the magnets 51 facing the core pieces 11, 12. That is, in comparison of area between the first and second core pieces 11, 21 facing one magnetic pole, there is a portion where the area of one of the first core piece 11 or the second core piece 21 is greater than that of the other. The first core piece 11 and the second core piece 21 have different polarities at this portion. Thus, one magnetic pole of the magnet 51 receives gravity toward the core piece having the greater area, and the adjacent core piece and magnet subsequently repeat the same operation, thereby generating a driving torque of the rotor. Here, as long as the first core pieces and the second core pieces facing the magnets have different areas, the non-overlapping regions S₂ may not exist, but only the overlapping regions S₁ may exist. On the contrary, if it is designed only with the non-overlapping regions S₂ without the overlapping regions S₁, there may be a dead point where the rotor does not receive a force of the rotational direction. Thus, the overlapping regions S₁ must exist.

The left top figure in FIG. 3 illustrates an example that the overlapping region S₁ and the non-overlapping region S₂ may have. The left bottom figure is to compare the areas when the first core pieces 11 and the second core pieces 21 face the magnets 51. In comparison of area between the first core pieces 11 and the second core pieces 21 in the overlapping region S₁ facing one magnetic pole of the magnets 51, the area of any one is always greater than that of the other. That is, in the overlapping region S₁, the first core pieces 11 and the second core pieces 21 have an asymmetric shape with different areas.

This also applies to the case where the polarities of the first and second core pieces 11, 21 are switched, as illustrated in the right figures. If an alternating current is applied to the coil to switch the polarities as illustrated in the left and right figures, the rotor rotates in the rotational direction.

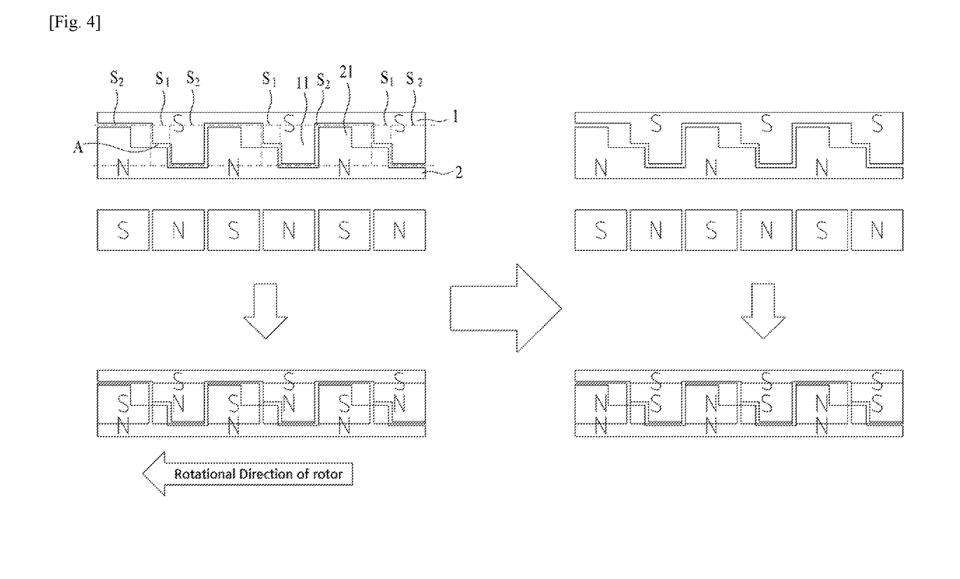

FIG. 4 is a development view of the core pieces and magnets in another shape for explaining the driving principle of the single phase brushless motor according to the present invention.

With reference to FIG. 4, it is almost the same as the example above except that the shape of the overlapping region S₁ is different from that of FIG. 3. In FIG. 4, the first core pieces 11 and the second core pieces 21 have the linear shape, whereas in FIG. 3, the core pieces overlap with each other in the oblique shape. Even with such shape, the first core pieces 11 and the second core pieces 21 facing one magnetic pole of the magnet have different areas. Meanwhile, part of the core pieces in the non-overlapping regions S₂ may have a notched shape.

In comparison of area between the first core piece 11 and the second core piece 21 in the overlapping region S₁ in FIG. 3 and FIG. 4, the core pieces have an asymmetric shape with different areas. Of course, the core pieces may have a symmetric shape as in the following example.

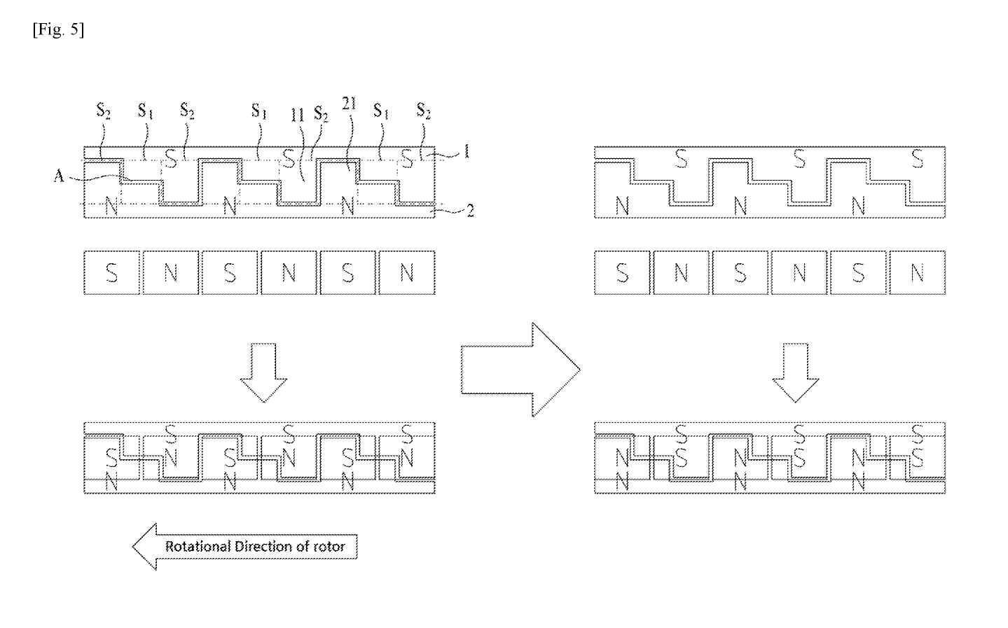

FIG. 5 is a development view of the core pieces and magnets in yet another shape for explaining the driving principle of the single phase brushless motor according to the present invention.

As illustrated in FIG. 5, in comparison of area between the first core pieces 11 and the second core pieces 21 in the overlapping regions S₁ in FIG. 3 and FIG. 4, the core pieces have a symmetric shape with the same area. Even with such shape, the first core pieces 11 and the second core pieces 21 facing one magnetic pole of the magnet have different areas.

The detailed description of the present invention explained as above simply explains examples for understanding the present invention, but does not intend to limit the scope of the present invention. The scope of the present invention is determined by the accompanying claims. Additionally, it should be construed that a simple modification or change falls under the protection scope of the present invention.

What is claimed is:

1. A single phase brushless direct current motor comprising a stator and a rotor which is rotatably located inside the stator,
the stator comprising:
a first stator core having a plurality of first core pieces which are formed to be bent from the inside;
a second stator core having a plurality of second core pieces which are located between the first core pieces, respectively, and are formed to be bent from the inside; and
a bobbin which is coupled between the first stator core and the second stator core, and around which a coil is wound, and
the rotor comprising:
a rotor body which rotates around a shaft; and
a plurality of magnets which are formed on the outer circumferential surface of the rotor body,
wherein the first core pieces and the second core pieces have overlapping regions which axially overlap when seen from the shaft.

2. The single phase brushless direct current motor of claim 1, wherein the end line of the first core piece and the end line of the second core piece have a certain interval therebetween.

3. The single phase brushless direct current motor of claim 1, wherein the outer circumference of the first stator core and the outer circumference of the second stator core are in contact with each other in at least a portion thereof.

4. The single phase brushless direct current motor of claim 1, wherein non-overlapping regions in which the first core pieces and the second core pieces do not overlap are located adjacent to the overlapping regions, and the non-overlapping region and the overlapping region are alternately located.

5. The single phase brushless direct current motor of claim 1, wherein the first core pieces and the second core pieces in the overlapping regions have an asymmetric shape with different areas.
